(19) United States
(12) Patent Application Publication
(10) Pub. No.: US 2008/0123122 A1
(43) Pub. Date: May 29, 2008

(54) Image Processing Device Having a Cover Capable of Moving Straight for Covering at Least a Portion of a Surface of an Object Sticking Out of a Main Body

(76) Inventors: Chen-Tsai Tsai, Hsinchu City (TW); Keng-Wei Shih, Chiayi City (TW)

Correspondence Address: NORTH AMERICA INTELLECTUAL PROPERTY CORPORATION, P.O. BOX 506, MERRIFIELD, VA, 22116, US

(21) Appl. No.: 11/759,946

(22) Filed: Jun. 8, 2007

(30) Foreign Application Priority Data
Nov. 23, 2006 (TW) 095143360

(51) Int. Cl. G06K 15/00

(52) U.S. Cl. 358/1.12

(57) ABSTRACT

The present invention provides an image processing device including a main body, a cover, and an object feeder. The main body has a space, where a first side of the space is a first opening of the main body, and a second side of the space is a second opening of the main body. The cover is movably coupled to the main body and is capable of moving straight. The object feeder is used for loading at least one object to be processed. When the object feeder is put into the space via the first opening and a portion of a surface of the object sticks out from the main body via the second opening, the cover moves straight to cover at least the portion of the surface.

### BACKGROUND OF THE INVENTION

1. Field of the Invention

The present invention relates to an image processing device, and more particularly, to an image processing device (such as a printing device) having a cover capable of moving straight for protecting objects to be processed.

2. Description of the Prior Art

With recent advancements in technology, electronic products have a trend of minimization. The sizes of printers also become smaller. The size of a paper-feeding tray is greater than the main body of a printer, making the paper-feeding tray stick out from the main body of the printer, which will result in the inability to protect media to be printed (that is to say papers) or to provide a dustproof environment when larger papers are used for printing. The printer can not be closed if the size of the paper-feeding tray is greater than the main body of the printer, which will increase its volume of packing and will increase its cost of carriage. The volume of the main body of the printer needs to be greater than the length of larger papers in order to support larger papers that do not meet the trend of minimization of the electronic products. Hence, it becomes an important topic of designing a printer to support larger papers for printing while providing dustproof functions in the main body of a small volume printer.

### SUMMARY OF THE INVENTION

It is therefore an objective of the present invention to provide an image processing device (such as a printing device) having a cover capable of moving straight for protecting at least one object to be processed to solve the above-mentioned problems.

An image processing device is disclosed in the present invention. The image processing device includes a main body, a cover, and an object feeder. The main body has a space, where a first side of the space is a first opening of the main body, and a second side of the space is a second opening of the main body. The cover is movably coupled to the main body and is capable of moving straight. The object feeder is used for loading at least one object to be processed. When the object feeder is put into the space via the first opening and a portion of a surface of the object sticks out from the main body via the second opening, the cover moves straight to cover at least the portion of the surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a cross-section structure of an image processing device according to a first embodiment of the present invention.

FIG. 2 is a three-dimensional diagram of the cover shown in FIG. 1.

FIG. 3 is a diagram illustrating the cover having not been pushed by the object feeder shown in FIG. 1.

FIG. 4 is a diagram illustrating the cover having been pushed by the object feeder shown in FIG. 1.

FIG. 5 is a three-dimensional diagram of the cover shown in FIG. 1 connected to an elastic element.

FIG. 6 is a diagram of a cross-section structure of an image processing device according to a second embodiment of the present invention.

### DETAILED DESCRIPTION

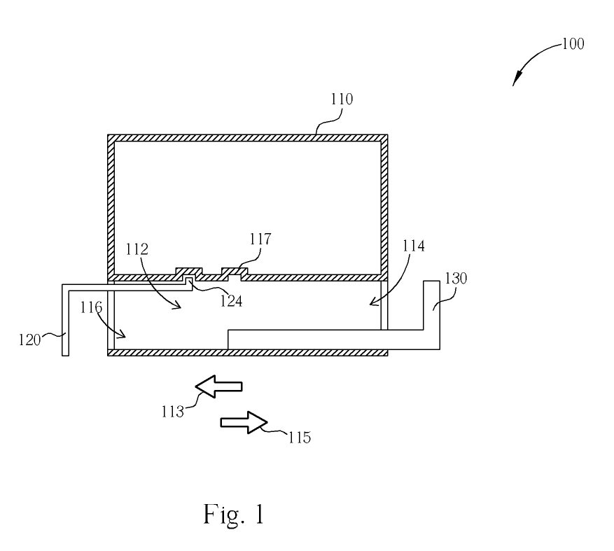

Please refer to FIG. 1, which is a diagram of a cross-section structure of an image processing device 100 according to a first embodiment of the present invention. In this embodiment, the image processing device 100 is explained by a printing device, but the image processing device in the present invention is not limited to a printing device only and can be other electronic devices needing to cover exposed objects to be processed. As shown in FIG. 1, the image processing device 100 includes a main body 110, a cover 120, and an object feeder 130. The main body 110 includes a space 112 and at least one clip notch 117. A first side of the space 112 is a first opening 114 of the main body 110, and a second side of the space 112 is a second opening 116 of the main body 110. The object feeder 130 is used for loading at least one object to be processed, and in one embodiment of the present invention, the object feeder is a cut-sheet feeder and the objects to be processed are papers. Furthermore, the cover 120 is movably coupled to the main body 110 and is capable of moving straight. For example, the cover 120 moves straight along a first direction 113 or a second direction 115 shown in FIG. 1.

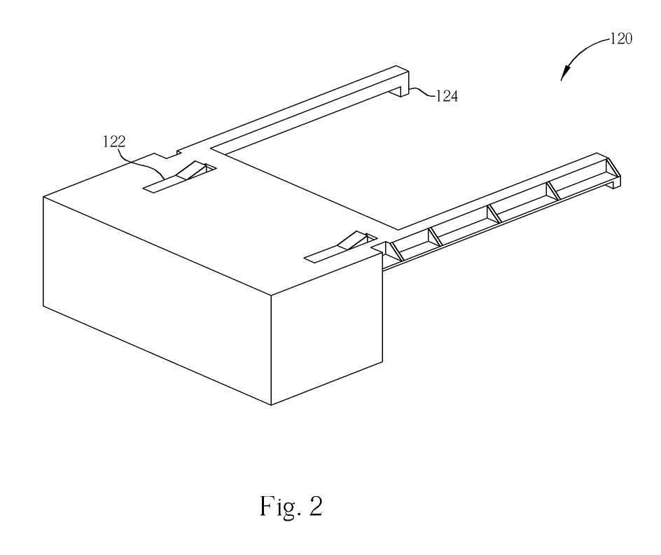

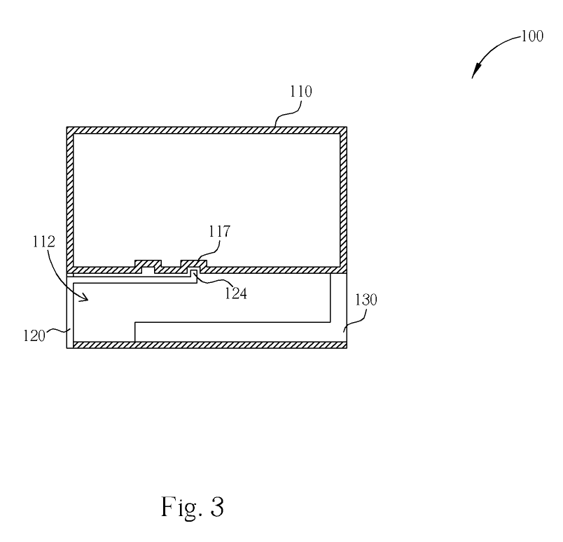

Please refer to FIG. 2. FIG. 2 is a three-dimensional diagram of the cover 120 shown in FIG. 1. As shown in FIG. 2, the cover 120 includes at least one tenon 122 and at least one block part 124. Please keep referring to FIG. 1, where the block part 124 is coupled to a clip notch 117 for preventing the cover 120 from moving straight along the first direction 113 continuously after the cover 120 moves straight along the first direction 113 for a specific distance. In this embodiment, the cover 120 is installed in the second side of the space 112 (that is the position of the second opening 116). Please notice that, the cover 120 will not move straight due to being driven by the object feeder 130 but will be located at the start position to cover the second opening 116 when the object feeder 130 is put into the space 112 via the first opening 114, and the object does not stick out from the main body 110 via the second opening 116 (that is a sum of a length of the object feeder 130 and a length of the object is not greater than a length of the main body 110 of the image processing device 100). Its status is shown in FIG. 3, and FIG. 3 is a diagram illustrating the cover 120 having not been pushed by the object feeder 130 shown in FIG. 1.

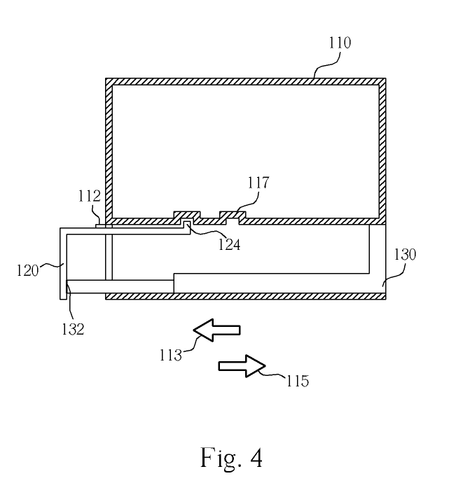

Nevertheless, when the length of the object is greater than the length of the main body 110 of the image processing device 100, for example, a longer object feeder 130 is utilized or the length of an adjustable object feeder 130 is adjusted to contain a larger object, one terminal of the object feeder 130 will directly contact with the cover 120 after being put into the space 112. Please refer to FIG. 4, which is a diagram illustrating the cover 120 having been pushed by the object feeder 130 shown in FIG. 1. As shown in FIG. 4, one terminal 132 of the object feeder 130 directly contacts with the cover 120 to drive the cover 120 to move straight along the first direction 113 which makes a portion of a surface of the object loaded by the object feeder 130 stick out from the main body 110 via the second opening 116 when the object feeder 130 is used for loading the longer object and when the object feeder 130 is put into the space 112 via the first opening 114 along the first direction 113. As a result, the cover 120 in the present invention moves straight along the first direction 113 to cover at least the portion of the surface for providing dustproof and waterproof effects. At this time, the block part 124 is coupled to the clip notch 117 to prevent the cover 120 from continuing to move straight along the first direction 113. In this embodiment, the tenon 122 is exactly against the main body 110 to prevent the cover 120 from moving straight along the second direction 115 opposite to the first direction 113 when the block part 124 is embedded into the clip notch 117. That is, the tenon 122 and the clip notch 117 are used for providing a function of fixing the cover 120 to prevent improper motions of the object feeder 130 caused by users mis-touching the cover 120 outside the main body 110. In another word, the cover 120 in the present invention not only provides the dustproof and waterproof functions, but also provides the fixing function 120 to prevent improper motions of the object feeder 130. Once the users want to retract the cover 120, only if the tenon 122 is pushed and the cover 120 is driven along the second direction 115 to make the block part 124 leave the clip notch 117 will the cover 120 be restored back to the original position shown in FIG. 3.

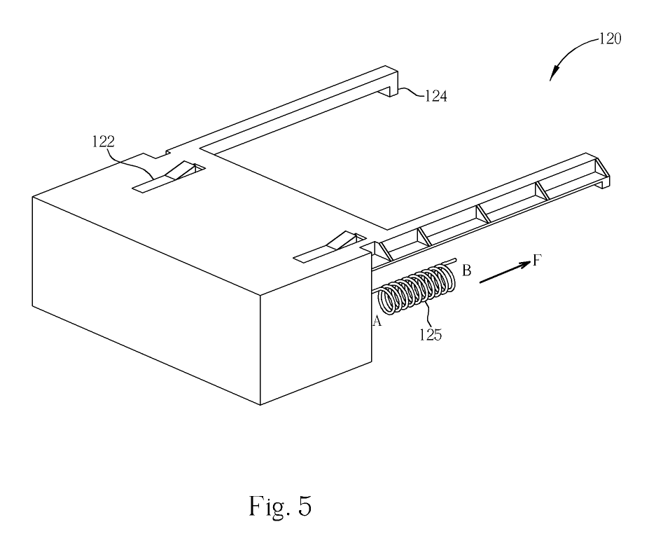

Please note that the tenon 122 is not limited to being installed on an upper surface of the cover 120, and could be installed on a surface flanked the cover 120. Moreover, the tenon 122 could be a flexible prominence that is monolithically formed with the cover 120 in practice. The image processing device in the present invention can further include an elastic element having two ends coupled to the cover 120 and to the main body 110 individually for providing a recovering elasticity after the cover 120 leaves the start position. Once the users want to retract the cover 120, only if the tenon 122 is pushed will the recovering elasticity restore the cover 120 to the original position shown in FIG. 3. Please refer to FIG. 5, which is a three-dimensional diagram of the cover 120 shown in FIG. 1 connected to an elastic element 125. One end A of the elastic element 125 (such as a spring) is fastened on the cover 120, and another end B is fastened on the main body 110 for providing the above-mentioned recovering elasticity F.

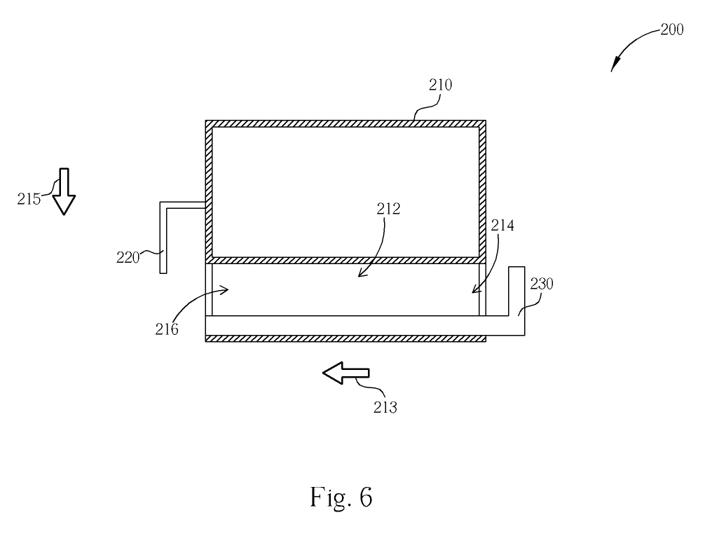

Please refer to FIG. 6. FIG. 6 is a diagram of a cross-section structure of an image processing device 200 according to a second embodiment of the present invention. In this embodiment, the image processing device 200 includes a main body 210, a cover 220, and an object feeder 230. The main body 210 includes a space 212, where a first side of the space 212 is a first opening 214 of the main body 210, and a second side of the space 212 is a second opening 216 of the main body 210. Furthermore, the cover 220 is movably coupled to the main body 210 and is capable of moving straight. Please notice that, the cover 220 is installed outside the main body 210. As shown in FIG. 6, the cover 220 will move straight along a second direction 215 driven by the object feeder 230 (for example, driven through an electronic auto-detecting device, a gear set, a connect line, or any prior driving mechanism) when the object feeder 230 is put into the space 212 via the first opening 214 along a first direction 213 and a portion of a surface of the object sticks out from the main body 210 via the second opening 216. Finally, the cover 220 will move straight along the second direction 215 to cover at least the portion of the surface for providing the dustproof and waterproof functions.

Compared with the prior art, the cover in the present invention is used as a security lid, which can move straight (can move horizontally or move vertically) relative to the main body of the image processing device (such as a printing device). As a result, it is easy for the users to utilize to reach an object of providing the dustproof and waterproof functions. Therefore, not only can huge size papers be contained, but also the length and the volume of the main body of a printer does not need to be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing device comprising:
a main body having a space, where a first side of the space is a first opening of the main body, and a second side of the space is a second opening of the main body;
a cover movably coupled to the main body and capable of moving straight; and
an object feeder used for loading at least one object to be processed;
wherein when the object feeder is put into the space via the first opening and a portion of a surface of the object sticks out from the main body via the second opening, the cover moves straight to cover at least the portion of the surface.

2. The image processing device of claim 1, wherein the cover moves straight due to being driven by the object feeder.

3. The image processing device of claim 2, wherein one terminal of the object feeder directly contacts with the cover to drive the cover to move straight.

4. The image processing device of claim 1, wherein the cover is installed in the second side of the space, and the cover will not move straight but will cover the second opening when the object feeder is put into the space via the first opening and the object does not stick out from the main body via the second opening.

5. The image processing device of claim 1, wherein the object feeder is put into the space via the first opening along a first direction, and the cover comprises at least one tenon used for preventing the cover from moving straight along a second direction opposite to the first direction after the cover moves straight along the first direction for a specific distance.

6. The image processing device of claim 5, wherein the tenon is a flexible prominence that is monolithically formed with the cover.

7. The image processing device of claim 5, wherein the main body comprises at least one clip notch, and the cover further comprises at least one block part movably coupled to the clip notch for preventing the cover from moving straight along the first direction continuously after the cover moves straight along the first direction for the specific distance.

8. The image processing device of claim 1, wherein the main body comprises at least one clip notch, and the cover further comprises at least one block part movably coupled to the clip notch for preventing the cover from moving straight along the first direction continuously after the cover moves straight along the first direction for the specific distance.

9. The image processing device of claim 1, wherein the cover moves straight to cover at least the portion of the surface from a start position, and the image processing device further comprises an elastic element having two ends coupled to the cover and to the main body individually for providing a recovering elasticity after the cover leaves the start position.

10. The image processing device of claim 1, wherein the image processing device is a printing device.

11. The image processing device of claim 1, wherein the object feeder is a cut-sheet feeder.
